(19) United States
(12) Patent Application Publication
(10) Pub. No.: US 2011/0003078 A1
(43) Pub. Date: Jan. 6, 2011

(54) APPARATUS FOR TREATING SURFACE AND METHOD OF TREATING SURFACE

(75) Inventors: Kippei Sugita, Nirasaki City (JP); Hiroyuki Hashimoto, Nirasaki City (JP); Muneo Harada, Nirasaki City (JP)

Correspondence Address: CANTOR COLBURN LLP, 20 Church Street, 22nd Floor, Hartford, CT, 06103, US

(73) Assignee: TOKYO ELECTRON LIMITED, Tokyo (JP)

(21) Appl. No.: 12/921,643

(22) PCT Filed: Mar. 13, 2009
(86) PCT No.: PCT/JP2009/054885

§ 371 Date: Sep. 9, 2010

(30) Foreign Application Priority Data
Mar. 25, 2008 (JP) 2008-078812

(51) Int. Cl. B05D 3/10; B05C 11/11

(52) U.S. Cl. 427/301; 118/64

(57) ABSTRACT

An aqueous solution containing an adhesion promoter in an amount of 20 vol. % or more is heated and vaporized to a temperature of 80 to 100° C. to produce a water-containing adhesion promoter vapor, and the water-containing adhesion promoter vapor is adhered to and condensed on a surface of a substrate, to cause a heating and dehydrating reaction by which the adhesion promoter is adhered to the surface of the substrate.

### TECHNICAL FIELD

The present invention relates to an apparatus and method for treating a surface of a substrate, and more particularly, to an apparatus and method for treating a surface of a substrate suitable for forming an organic film through a thermal polymerization reaction. Also, the present invention relates to a film forming apparatus and method using the apparatus and method for treating the surface of the substrate.

### BACKGROUND ART

A polymer organic film may be used as an interlayer insulating film of LSI or the like, or a liquid crystal alignment layer, and has very excellent electrical, optical, and mechanical characteristics. In particular, since, for example, polyimide or the like has a high glass transition point and has excellent heat resistance, chemical stability, alignment control, and the like, polyimide or the like is used as a heat- and radiation-resistant material and a space-survival material, and is also being considered to be used as an insulating material of a superconducting magnet used in a fusion reactor, a protective material for preventing degradation of a material for machinery due to atomic oxygen in space, or the like.

As a method for obtaining such a polymer organic film, a conventional method of polymerizing a monomer by using a solvent to obtain a solution and coating the solution on a substrate is known. However, since the conventional method uses the solvent, impurity introduction or the like occurs and it is difficult to obtain a thin film having a uniform thickness less than 1000 Å. Also, as a method for obtaining a monomolecular layer film, manufacture of a thin film using a Langmuir-Blodgett (LB) method has been studied. However, since reactions, such as substitution of hydrophilic and hydrophobic groups and the like, are complicated and, it is difficult to control a surface pressure required when the thin film is obtained, it is difficult to obtain a thin film with a large area. Also, since a solvent is used during polymerization or the like, impurity introduction occurs as well.

Meanwhile, contrary to such a wet process, a deposition polymerization method (vacuum deposition polymerization method) for directly obtaining an organic film by vaporizing a material monomer in a vacuum vessel and polymerizing the vaporized material monomer on a substrate has been suggested. Since this method is a dry process under a non-thermal equilibrium state, an organic film that may not be obtained in a conventional chemical wet process may be obtained. Since the material monomer is introduced into and adhered to a protrusion/recess portion of the substrate, this method may form a film with good coverage (Patent Document 1).

However, the deposition polymerization method has disadvantages in that an adhesiveness between the polymer organic film and the substrate is small, and particularly in case that a semiconductor substrate is used as the substrate, adhesiveness tends to be drastically reduced.

In this regard, in the conventional art, it has been attempted to increase adhesiveness between the substrate and the polymer organic film using an adhesion promoter by preparing an aqueous solution containing the adhesion promoter, such as a silane coupling agent or the like, immersing the substrate in the solution, and adhering the adhesion promoter to a surface of the substrate.

In the method of immersing the substrate in the aqueous solution, since the aqueous solution containing the adhesion promoter is first coated on the surface of the substrate and then the coated aqueous solution is dried, only the adhesion promoter remains on the surface of the substrate. However, in this case, it is difficult to uniformly coat the aqueous solution on the surface of the substrate, and the aqueous solution is gathered on the surface, whereby an excessive residue may be produced after the drying. Accordingly, if a polymer organic film is then formed on the surface of the substrate by using the deposition polymerization method or the like, the residue may badly affect the polymer organic film.

In this regard, Patent Document 2 discloses a method of suppressing the production of a residue due to a gathered solution as described above by introducing a silane coupling agent as a vapor into a processing container and adhering the silane coupling agent vapor to a surface of a substrate. However, this method has a disadvantage in that adhesiveness between the substrate and a polymer organic film to be formed later is not sufficiently improved.

(Patent Document 1) Specification of Japanese Patent No. 3758696

(Patent Document 2) Japanese Laid-Open Patent Publication No. 2006-231134

### DISCLOSURE OF THE INVENTION

### Technical Problem

The present invention is proposed considering the above problems. According to the present invention, it may be obtained to improve adhesiveness between a substrate, particularly, a semiconductor substrate, and a polymer organic film without producing a residue on the substrate due to an adhesion promoter.

### Technical Solution

According to the present invention, there is provided an apparatus for treating a surface of a substrate (first treating apparatus), the apparatus including: a holding container which holds an aqueous solution containing an adhesion promoter in an amount of 20 vol. % or more; a heater for vaporizing which produces a water-containing adhesion promoter vapor by heating and vaporizing the aqueous solution in the holding container to a temperature of 80° to 100° C.; a heater for heating and dehydrating which causes a heating and dehydrating reaction after the water-containing adhesion promoter vapor is adhered to and condensed on the surface of the substrate, so as to chemically couple the adhesion promoter to the surface of the substrate; and a processing container which holds the adhesion promoter vapor by receiving at least the holding container.

Also, the present invention provides an apparatus for treating a surface of a substrate (second treating apparatus), the apparatus including: a first holding container which holds an undiluted solution of an adhesion promoter; a second holding container which holds water; a first heater for vaporizing which produces an adhesion promoter vapor by heating and vaporizing the undiluted solution of the adhesion promoter in the first holding container; a second heater for vaporizing which produces a water vapor by heating and vaporizing the water in the second holding container; a heater for heating and dehydrating which chemically couples the adhesion promoter to the surface of the substrate after the water vapor and the adhesion promoter vapor, in which the ratio of the adhesion promoter is greater than a predetermined mixture ratio, is adhered to the surface of the substrate and hydrolyzed; and a processing container which is connected to at least the first holding container and the second holding container to hold the adhesion promoter vapor and the water vapor.

Also, the present invention provides a method of treating a surface of a substrate (first treating method), the method including: holding in a holding container an aqueous solution, which contains an adhesion promoter in an amount of 20 vol. % or more; heating and vaporizing the aqueous solution to a temperature of 80 to 100° C. by using a heater for vaporizing to produce a water-containing adhesion promoter vapor, and holding the water-containing adhesion promoter vapor in a processing container; and causing a heating and dehydrating reaction by using a heater for heating and dehydrating after the water-containing adhesion promoter vapor is adhered to and condensed on the surface of the substrate, so as to dehydrate and condense the adhesion promoter on the surface of the substrate.

Also, the present invention provides a method of treating a surface of a substrate (second treating method), the method including: holding an undiluted solution of an adhesion promoter in a first holding container; holding water in a second holding container; heating and vaporizing the undiluted solution of the adhesion promoter in the first holding container by using a first heater for vaporizing to produce an adhesion promoter vapor, and holding the adhesion promoter vapor in a processing container; heating and vaporizing the water in the second holding container by using a second heater for vaporizing to produce a water vapor, and holding the water vapor in the processing container; and after the water vapor and the adhesion promoter vapor, in which the ratio of the adhesion promoter is greater than a predetermined mixture ratio, is adhered to the surface of the substrate and hydrolyzed, dehydrating and condensing the adhesion promoter by using a heater for heating and dehydrating so as to chemically couple the adhesion promoter to the surface of the substrate.

According to the present invention, since an adhesion promoter is adhered as a vapor, not as a solution, to a surface of a substrate, the production of a residue due to a gathered solution generated when the solution is coated may be suppressed. Thus, the residue is prevented from badly affecting a polymer organic film formed on the surface of the substrate, and thus from deteriorating of the characteristics of the polymer organic film.

Also, in the first film forming apparatus and the first film forming method, since an aqueous solution containing the adhesion promoter is prepared in advance and the aqueous solution is heated and vaporized, obtained vapors include the adhesion promoter and a water vapor. Accordingly, the adhesion promoter is adhered to the surface of the substrate. Accordingly, the adhesion promoter and water react with each other on the surface, and thus a functional group with sufficient reactivity is exposed on a surface of the adhesion promoter.

Also, in the first film forming apparatus and the first film forming method, the vapors are adhered to and condensed on the surface of the substrate, and then heating is performed. Accordingly, the adhesion promoter is dehydrated and condensed, and thus the functional group exposed on the surface of the adhesion promoter reacts with the surface of the substrate. Accordingly, adhesive force between the adhesion promoter and the substrate is improved.

Meanwhile, since the functional group also reacts with a polymer organic film to be formed later, an adhesive force between the adhesion promoter and the polymer organic film is also improved. Accordingly, an adhesive force between the substrate and the polymer organic film is improved by interposing the adhesion promoter, which has gone through the hydrolysis reaction and the dehydration reaction as described above, between the substrate and the polymer organic film.

Also, in the first film forming apparatus and the first film forming method, the amount of the adhesion promoter contained in an aqueous solution is greater than 20 vol. %, and the aqueous solution is heated to a temperature of 80 to 100° C. These are parameter conditions obtained after investigating various parameters in order to supply a sufficient amount of the adhesion promoter to the surface of the substrate, by considering that a boiling point of water is 100° C. and a boiling point of the adhesion promoter is greater than about 200° C.

Also, “water-containing adhesion promoter vapor” means that an adhesion promoter vapor contains water irrespective of its state. However, since the “water-containing adhesion promoter vapor” is obtained by heating the aqueous solution containing the adhesion promoter, the “water-containing adhesion promoter vapor” narrowly means a vapor obtained by mixing the adhesion promoter vapor and a water vapor.

Also, in the second film forming apparatus and the second film forming method, an undiluted solution containing the adhesion promoter and water are separately prepared, and the undiluted solution and the water are independently heated and vaporized so that the ratio of the adhesion promoter is greater than a predetermined mixture ratio. Accordingly, the vapor of the adhesion promoter and the water vapor are adhered to and condensed on the surface of the substrate. Accordingly, the adhesion promoter and the water react with each other to cause a hydrolysis on the surface, and thus a functional group with sufficient reactivity is exposed on a surface of the adhesion promoter.

Also, in the second film forming apparatus and the second film forming method, the vapors are adhered to and condensed on the surface of the substrate, and then heating is performed. Accordingly, the adhesion promoter is hydrolyzed and then dehydrated, and thus the functional group exposed on the surface of the adhesion promoter chemically reacts with the surface of the substrate. Accordingly, an adhesive force between the adhesion promoter and the substrate is improved.

Meanwhile, since the functional group also reacts with a polymer organic film to be formed later, an adhesive force between the adhesion promoter and the polymer organic film is also improved. Accordingly, an adhesive force between the substrate and the polymer organic film is also improved by interposing the adhesion promoter, which has gone through the hydrolysis reaction and the dehydration reaction as described above, between the substrate and the polymer organic film.

Also, in the second film forming apparatus and the second film forming method, since an undiluted solution containing the adhesion promoter and water are separately prepared, the amount of a vapor of the adhesion promoter and the amount of a water vapor may be independently controlled. That is, since an amount of the adhesion promoter and the water supplied to the surface of the target substrate may be freely controlled, a degree of the aforesaid hydrolysis or the like may be freely controlled. Accordingly, an adhesive force between the substrate and the polymer organic film may be freely controlled.

Also, in one embodiment of the present invention, the heater for heating and dehydrating and the surface of the substrate are heated to a temperature of 100° or more. Accordingly, the heating and dehydrating reaction may be easily caused.

Also, in one embodiment of the present invention, the adhesion promoter is a silane coupling agent. Since the silane coupling agent is easily available, since a hydroxyl group with sufficient reactivity may be produced due to the aforesaid hydrolysis, and additionally, since the hydroxyl group is strongly coupled to oxygen or the like on the surface of the substrate through a heating and dehydrating reaction, adhesiveness between the substrate and a polymer organic film to be formed may be improved by the aforesaid mechanism.

Also, the aforesaid film forming apparatus and film forming method may be included in a film forming apparatus and method for forming a polymer organic film.

### ADVANTAGEOUS EFFECTS

As described above, according to the present invention, adhesiveness between a substrate, particularly, a semiconductor substrate, and a polymer organic film may be improved without producing a residue on the substrate due to an adhesion promoter.

### BRIEF DESCRIPTION OF THE DRAWINGS

FIG. 1 is a view schematically showing an embodiment of a configuration of an apparatus for treating a surface according to the present invention.

FIG. 2 is a view schematically showing the aforesaid mechanism for improving an adhesive force when a silane coupling agent is used as an adhesion promoter.

FIG. 3 is a diagram for explaining the aforesaid mechanism for improving the adhesive force when the silane coupling agent is used as the adhesion promoter.

FIG. 4 is a graph showing a relationship of an adhesive force between concentration of an adhesion promoter and a polymer organic film formed by interposing the adhesion promoter.

FIG. 5 is a view schematically showing another embodiment of a configuration of an apparatus for treating a surface according to the present invention.

FIG. 6 is a view schematically showing yet another embodiment of a configuration of an apparatus for treating a surface according to the present invention.

FIG. 7 is a view schematically showing an embodiment of a configuration of a film forming apparatus according to the present invention.

FIG. 8 is a view schematically showing another embodiment of a configuration of a film forming apparatus according to the present invention.

### BEST MODE FOR CARRYING OUT THE INVENTION

Hereinafter, specific features of the present invention will be explained based on best modes for carrying out the invention.

### First Embodiment

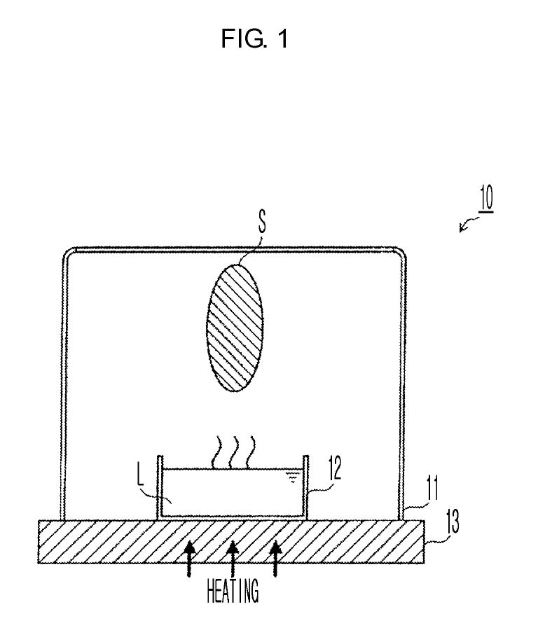

FIG. 1 is a view schematically showing an embodiment of a configuration of an apparatus for treating a surface according to the present invention. Also, in the present embodiment, the first apparatus and method for treating a surface will be explained.

In an apparatus for treating a surface 10 shown in FIG. 1, a holding container 12 is disposed at a lower portion in a processing container 11, and a heater for vaporizing 13 is additionally formed under the holding container 12 to seal the processing container 11 from the bottom. An aqueous solution L containing an adhesion promoter, for example, a silane coupling agent or the like, is filled in the holding container 12. Also, in the processing container 11, a substrate S is supported by a substrate holder (not shown) above the holding container 12. Also, in the processing container 11, a heater for heating and dehydrating (not shown) is formed near the substrate S.

Also, the heater for vaporizing 13 may be a heater using a general method such as a resistance heating method or the like. Also, the heater for heating and dehydrating may also be a heater using a general method.

The amount of the adhesion promoter contained in the aqueous solution L is 20 vol. % or more. This is a parameter condition for supplying a sufficient amount of the adhesion promoter to a surface of the substrate S in a treating method that will be explained later. If the condition is not satisfied, a sufficient amount of the adhesion promoter may not be supplied to the surface of the substrate, thereby failing to obtain the operational effect of the present invention, that is, to improve adhesiveness between the substrate S and a polymer organic film to be formed later.

Also, an upper limit on the amount of the adhesion promoter contained in the aqueous solution L is a maximum amount of the adhesion promoter that can dissolve in water. For example, if a silane coupling agent is used as the adhesion promoter, the upper limit is about 30% at room temperature.

Next, a method of treating a surface using the apparatus for treating a surface 10 shown in FIG. 1 will be explained. First, the aqueous solution L held in the holding container 12 is heated by the heater for vaporizing 13 to a temperature of 80 to 100° C. Then, the aqueous solution L is vaporized to produce a water vapor and an adhesion promoter vapor.

Also, the heating temperature of 80 to 100° C. is a parameter condition for supplying a sufficient amount of the adhesion promoter to the surface of the substrate S.

If the condition is not satisfied, a sufficient amount of the adhesion promoter is not supplied to the substrate surface, thereby failing to obtain the operational effect of the present invention, that is, to improve adhesiveness between the substrate S and a polymer organic film to be formed later.

Since the holding container 12 is held in the processing container 11, the water vapor and the adhesion promoter vapor diffuse upward in the processing container 11, and are adhered to and condensed on the surface of the substrate S. In this case, the adhesion promoter is hydrolyzed by reacting with water on the surface of the substrate S, and thus a functional group with sufficient reactivity is formed on a surface thereof. For example, if a silane coupling agent is used as the adhesion promoter, a hydroxyl group is formed.

Next, the surface of the substrate S is heated by the heater for heating and dehydrating, to cause a dehydration-condensation reaction with respect to the adhesion promoter. Then, the functional group exposed on the surface of the adhesion promoter reacts with the substrate S, and thus is strongly coupled to the substrate S. Accordingly, an adhesive force between the adhesion promoter and the substrate S is improved.

Meanwhile, since the functional group also reacts with a polymer organic film to be formed later, an adhesive force between the adhesion promoter and the polymer organic film is also improved. Accordingly, an adhesive force between the substrate S and the polymer organic film is improved by interposing the adhesion promoter, which has gone through the hydrolysis reaction and the dehydration reaction as described above, between the substrate S and the polymer organic film.

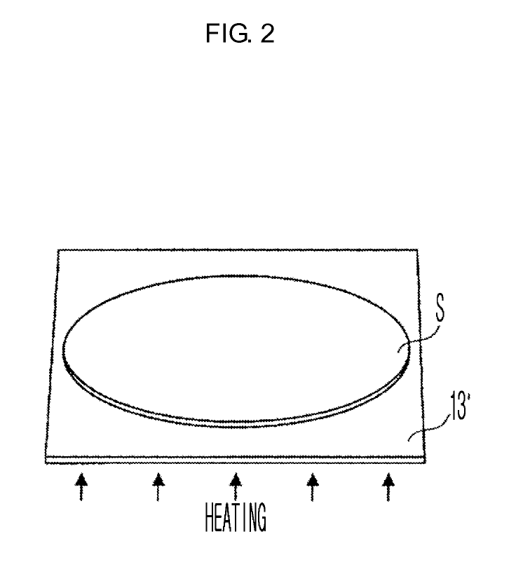

Also, the heating and dehydrating reaction may be performed in a separate batch. That is, in the processing container 11 as shown in FIG. 1, the water vapor and the adhesion promoter vapor from the holding container 12 are adhered to and condensed on the surface of the substrate S and then a hydrolysis is performed. Thereafter, the substrate S may be extracted from the processing container 11 and loaded on a heater for heating and dehydrating 13′ as shown in FIG. 2, to cause the heating and dehydrating reaction.

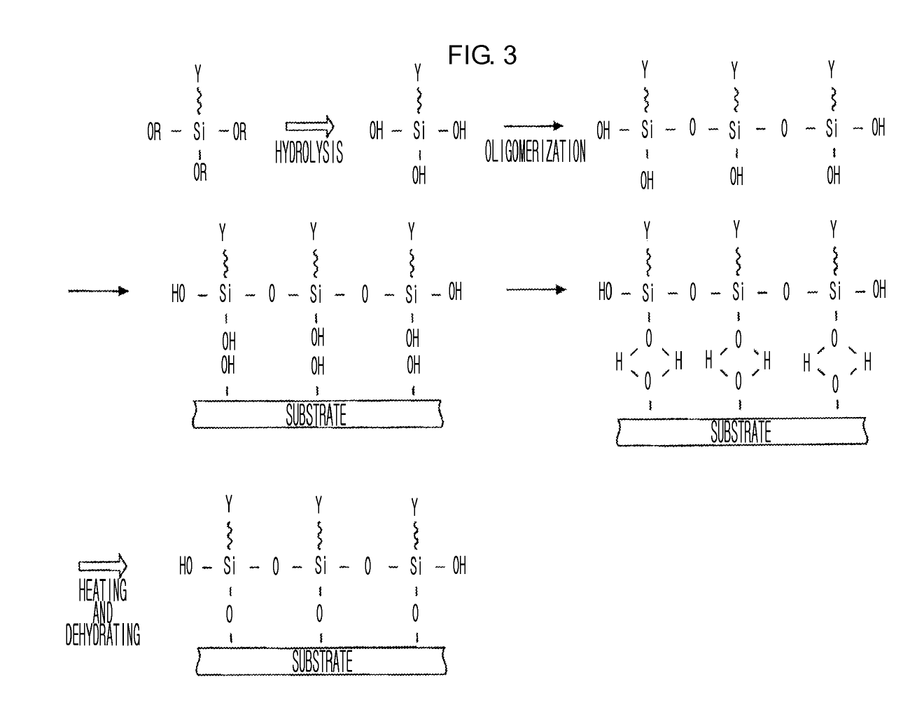

Also, in FIG. 3, if a silane coupling agent is used as the adhesion promoter, the aforesaid mechanism for improving adhesiveness was shown by structural formula.

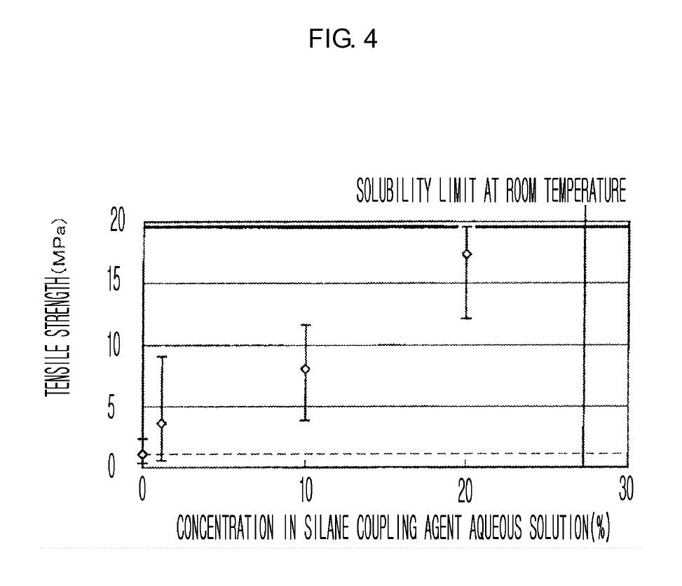

Also, a relationship between the concentration of the adhesion promoter in the adhesion promoter aqueous solution L in the holding container 12 and an adhesive force between the adhesion promoter and a polymer organic film formed by interposing the adhesion promoter were investigated. Results of the investigation are shown in FIG. 4. Also, a silane coupling agent was used as the adhesion promoter and a Si substrate was used as the substrate. Also, a polymer organic film formed on the Si substrate was a polyimide film (with a thickness of 1 μm).

It is found from FIG. 4 that if the concentration of the adhesion promoter in the adhesion promoter aqueous solution L exceeds 20 vol. %, an adhesive force between the Si substrate and the polyimide film is drastically increased. Also, the adhesive force was evaluated by fixing a tensile jig to each of a rear surface of the Si substrate and a surface of the polyimide film by interposing an adhesive, vertically stretching the tensile jig, and checking a tensile strength when the polyimide film is detached from the Si substrate.

### Second Embodiment

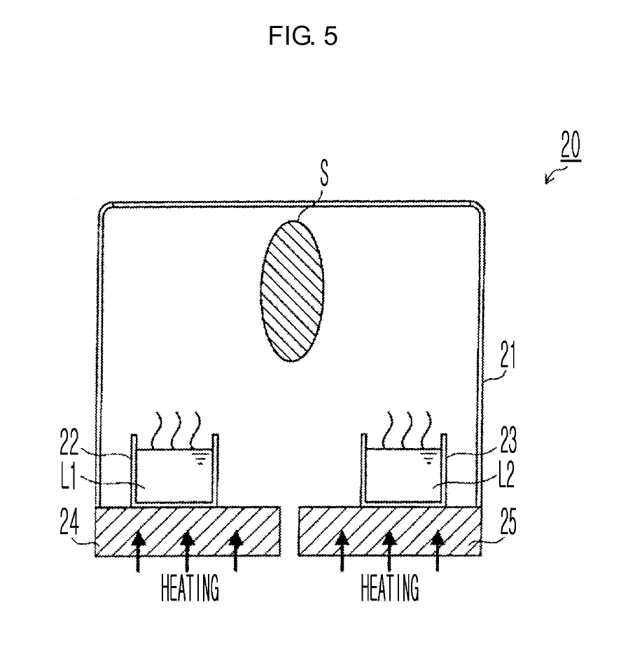

FIG. 5 is a view schematically showing another embodiment of a configuration of an apparatus for treating a surface according to the present invention. Also, in the present embodiment, the second apparatus and method for treating a surface will be explained.

In an apparatus for treating a surface 20 shown in FIG. 5, a first holding container 22 and a second holding container 23 are disposed at lower portions in a processing container 21, and a first heater for vaporizing 24 and a second heater for vaporizing 25 are additionally formed under each of the first holding container 22 and the second holding container 23, to seal the processing container 21 from the bottom. An undiluted solution L1 of an adhesion promoter, for example, a silane coupling agent or the like, is filled in the first holding container 22, and water is filled in the second holding container 23.

Also, in the processing container 21, a substrate S is supported by a substrate holder (not shown) above the first holding container 22 and the second holding container 23. Also, in the processing container 21, a heater for heating and dehydrating (not shown) is formed near the substrate S.

Also, each of the first heater for vaporizing 24 and the second heater for vaporizing 25 may be a heater using a general method such as a resistance heating method or the like. Also, the heater for heating and dehydrating may also be a heater using a general method.

Next, a method of treating a surface by using the apparatus for treating a surface 20 shown in FIG. 5 will be explained. First, the undiluted solution L1 of the adhesion promoter filled in the first holding container 22 and the water L2 filled in the second holding container 23 are respectively heated by the first heater for vaporizing 24 and the second heater for vaporizing 25, to vaporize the undiluted solution L1 and the water L2. In this case, temperatures of the first heater for vaporizing 24 and the second heater for vaporizing 25 are set so that a sufficient amount of vapor is produced from the undiluted solution L1 and the water L2 and that the ratio of the adhesion promoter is greater than a predetermined mixture ratio. For example, the first vaporizing container 24 heats the first holding container 22 to a temperature of about 200° C. or more, specifically, 250° C. to 260° C. Meanwhile, the second heater for vaporizing 25 heats the second holding container 23 to a temperature of 80° C. to 100° C.

Since the first holding container 22 and the second holding container 23 are held in the processing container 21, an adhesion promoter vapor obtained from the undiluted solution L1 and a water vapor obtained from the water L2 diffuse upward in the processing container 21, and are adhered to and condensed on a surface of the substrate S. At this time, the adhesion promoter is hydrolyzed by reacting with water on the surface of the substrate S, and thus a functional group with sufficient reactivity is formed on a surface thereof in the same manner as in the first embodiment. For example, if a silane coupling agent is used as the adhesion promoter, a hydroxyl group is formed.

Next, as described above, the surface of the substrate S is heated by the heater for heating and dehydrating, to cause a dehydration-condensation reaction with respect to the adhesion promoter having been hydrolyzed. Then, the functional group exposed on the surface of the adhesion promoter reacts with the substrate S, and is thus strongly coupled to the substrate S. Accordingly, an adhesive force between the adhesion promoter and the substrate S is improved.

Meanwhile, since the functional group also reacts with a polymer organic film to be formed later, an adhesive force between the adhesion promoter and the polymer organic film is also improved. Accordingly, an adhesive force between the substrate S and the polymer organic film is improved by interposing the adhesion promoter, which has gone through the hydrolysis reaction and the dehydration reaction as described above, between the substrate S and the polymer organic film.

Also, in the present embodiment, since the undiluted solution L1 containing the adhesion promoter and the water L2 are separately prepared, the amount of a vapor of the adhesion promoter (undiluted solution L1) and the amount of a water vapor (from the water L2) may be independently controlled. That is, since an amount of the adhesion promoter and the water supplied to the surface of the target substrate S may be freely controlled, a degree of the aforesaid hydrolysis or the like may be freely controlled. Accordingly, an adhesive force between the substrate S and the polymer organic film may be freely controlled.

Also, even in the present embodiment, the heating and dehydrating reaction may be performed in a separate batch as shown in FIG. 2.

### Third Embodiment

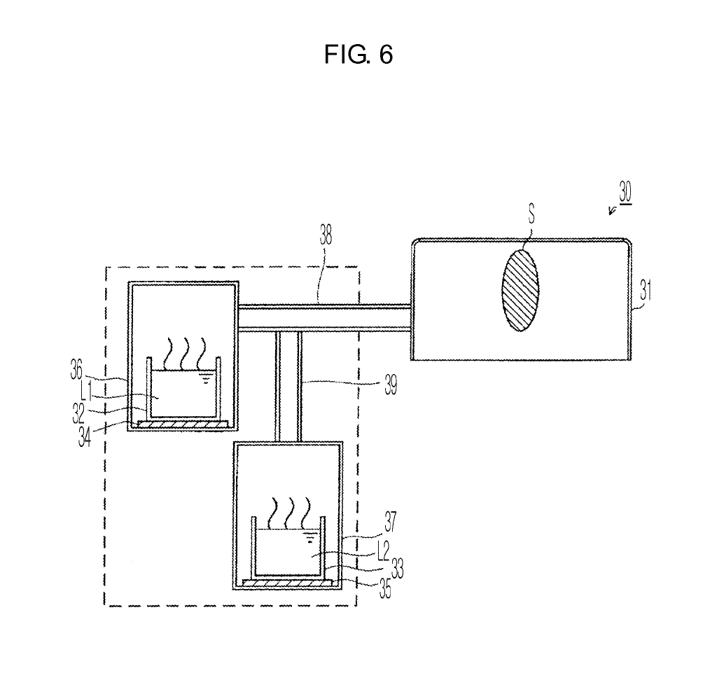

FIG. 6 is a view schematically showing yet another embodiment of a configuration of an apparatus for treating a surface according to the present invention. Also, the present embodiment is a modification of the second embodiment regarding the second apparatus and method for treating the surface.

In an apparatus for treating a surface 30 shown in FIG. 6, a substrate S is held by a substrate holder (not shown) in a processing container 31, and a first holding chamber 36 and a second holding chamber 37 are formed separately from the processing container 31 to respectively receive a first holding container 32 and a second holding container 33. Also, in the first holding chamber 36 and the second holding chamber 37, a first heater for vaporizing 34 and a second heater for vaporizing 35 are respectively formed under the first holding container 32 and the second holding container 33. An undiluted solution L1 of an adhesion promoter, for example, a silane coupling agent or the like, is filled in the first holding container 32, and water is filled in the second holding container 33.

The processing container 31 is connected to each of the first holding chamber 36 and the second holding chamber 37 through pipes 38 and 39. Also, although the pipes 38 and 39 are connected to each other on the way as shown in FIG. 6, in the present embodiment, the pipes 38 and 39 don't necessarily need to be connected to each other, and the processing container 31 and the first holding chamber 36 may be connected to each other through the pipe 38, and the processing container 31 and the second holding chamber 37 may be connected to each other through the pipe 39.

Also, even in the present embodiment, in the processing chamber 31, a heater for heating and dehydrating (not shown) is formed near the substrate S.

Also, each of the first heater for vaporizing 34 and the second heater for vaporizing 35 may be a heater using a general method such as a resistance heating method or the like. Also, the heater for heating and dehydrating may also be a heater using a general method.

Next, a method of treating a surface by using the apparatus for treating a surface 30 shown in FIG. 6 will be explained. First, the undiluted solution L1 of the adhesion promoter filled in the first holding container 32 and the water L2 filled in the second holding container 33 are respectively heated by the first heater for vaporizing 34 and the second heater for vaporizing 35, to vaporize the undiluted solution L1 and the water L2. In this case, temperatures of the first heater for vaporizing 34 and the second heater for vaporizing 35 are set so that a sufficient amount of vapor is produced from each of the undiluted solution L1 and the water L2 and the ratio of the adhesion promoter is greater than a predetermined mixture ratio. For example, the first heater for vaporizing 34 heats the undiluted solution L1 to a temperature of about 200° C. or more, specifically, 250° C. to 260° C. Meanwhile, the second heater for vaporizing 35 heats the water L2 to a temperature of 80° C. to 100° C.

An adhesion promoter vapor obtained from the undiluted solution L1 of the first holding container 32 and a water vapor obtained from the water L2 of the second holding container 33 respectively diffuse upward, are introduced into the processing container 31 through the pipes 38 and 39, and are adhered to and condensed on a surface of the substrate S. In this case, the adhesion promoter is hydrolyzed by reacting with water on the surface of the substrate S, and thus a functional group with sufficient reactivity is formed on a surface thereof in the same manner as that in the first embodiment. For example, if a silane coupling agent is used as the adhesion promoter, a hydroxyl group is formed.

Also, if the conductance of each of the pipes 38 and 39 is low, it is difficult to introduce the adhesion promoter vapor and the water vapor into the processing container 31 as described above. Accordingly, a carrier gas may be supplied into the pipes 38 and 39 along with the adhesion promoter and the water vapor, so as to assist the introduction of the adhesion promoter vapor and the water vapor into the processing container 31.

Next, as described above, the surface of the substrate S is heated by the heater for heating and dehydrating, to cause a dehydration-condensation reaction with respect to the adhesion promoter having been hydrolyzed. Then, the functional group exposed on the surface of the adhesion promoter reacts with the substrate S, and thus is strongly coupled to the substrate S. Accordingly, an adhesive force between the adhesion promoter and the substrate S is improved.

Meanwhile, since the functional group also reacts with a polymer organic film to be formed later, an adhesive force between the adhesion promoter and the polymer organic film is also improved. Accordingly, adhesiveness between the substrate S and the polymer organic film is improved by interposing the adhesion promoter, which has gone through the hydrolysis reaction and the dehydration reaction as described above, between the substrate S and the polymer organic film.

Also, even in the present embodiment, since the undiluted solution L1 containing the adhesion promoter and the water L2 are separately prepared, the amount of a vapor of the adhesion promoter (undiluted solution L1) and the amount of a water vapor (from the water L2) may be independently controlled. That is, since an amount of the adhesion promoter and the water supplied to the surface of the target substrate S may be freely controlled, a degree of the aforesaid hydrolysis or the like may be freely controlled. Accordingly, an adhesive force between the substrate S and the polymer organic film may be freely controlled.

Also, even in the present embodiment, the heating and dehydrating reaction may be performed in a separate batch as shown in FIG. 2.

### Fourth Embodiment

In the present embodiment, a film forming apparatus and method using the apparatus and the method for treating a surface according to the aforesaid embodiments will be explained.

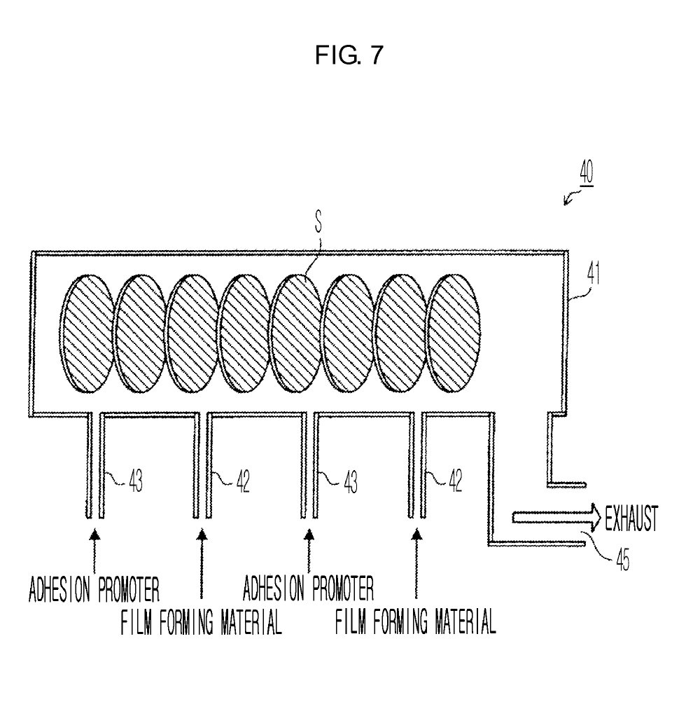

FIG. 7 is a view schematically showing an embodiment of a configuration of a film forming apparatus according to the present invention. A film forming apparatus 40 shown in FIG. 7 includes a film forming container 41. In the film forming container 41, a plurality of substrates S are held by a substrate supporting container, such as a boat (not shown), to be spaced apart from one another. Also, pipes 42 for introducing a material monomer and pipes 43 for introducing an adhesion promoter vapor and a water vapor obtained in the embodiments are alternately formed in a bottom surface of the film forming container 41. Also, an exhaust pipe 45 connected to an exhaust system (not shown) is formed in the right side of the film forming container 41.

Also, the holding container 12 or the like as shown in FIGS. 1 and 5, or a portion surrounded by a dashed line as shown in FIG. 6 is connected to the pipes 43, and thus a vaporized adhesion promoter aqueous solution or the like is introduced into the film forming container 41. However, since the substrates S are disposed inside the film forming container 41, the heater for heating and dehydrating in each of the apparatuses for treating a surfaces 10, 20, and 30 shown in FIGS. 1, 5, and 6 is formed in the film forming container 41, not in each of the processing containers 11, 21, and 31.

In the film forming apparatus 40 shown in FIG. 7, like the apparatuses for treating a surfaces 10, 20, and 30 described with reference to FIGS. 1, 5, and 6, after an adhesion promoter vapor and a water vapor are first produced in the holding container 12 or the like or the first holding container 36 or the like, the adhesion promoter vapor and the water vapor are introduced into the film forming container 41 through the pipes 43, to cause the hydrolysis reaction and the heating and dehydrating reaction (on surfaces of the substrates S) in the film forming container 41 (pre-processing). Also, a remaining part of the adhesion promoter vapor or the like is exhausted to the outside from the film forming container 41 through the exhaust pipe 45.

Next, the substrates S are held at a predetermined temperature, a material monomer is introduced from the pipes 42 into the film forming container 41 to cause a thermal polymerization reaction, and thus a polymer organic film is formed on the surfaces of the substrates S. Since the adhesion promoter is interposed between the substrate S and the polymer organic film due to the pre-processing, an adhesive force between the substrates S and the polymer organic film is improved.

Also, a remaining part of the material monomer not contributing to the thermal polymerization reaction is exhausted to the outside from the film forming container 41 through the exhaust pipe 45.

### Fifth Embodiment

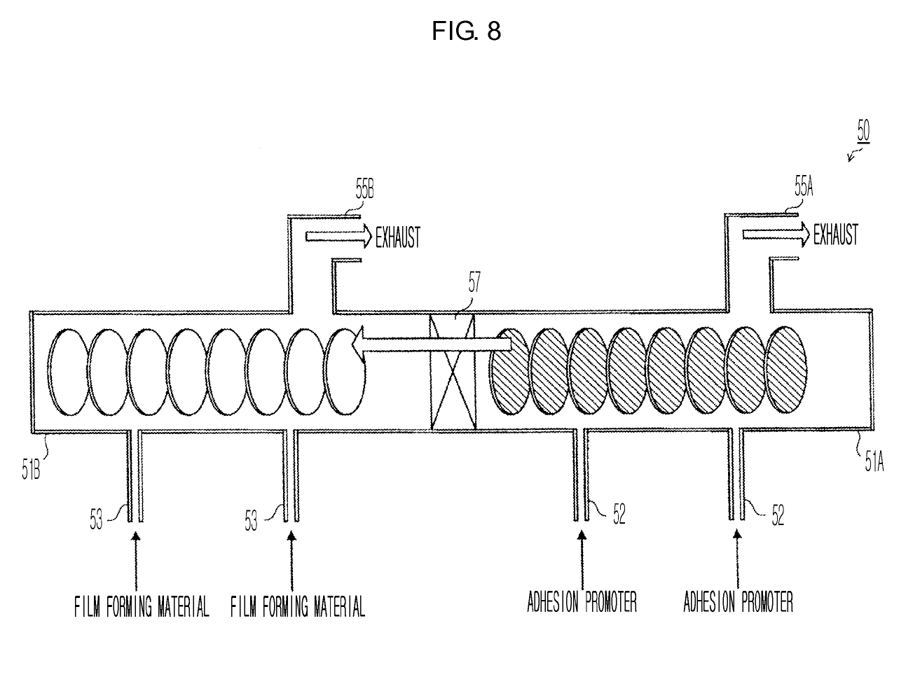

FIG. 8 is a view schematically showing another embodiment of a configuration of a film forming apparatus according to the present invention. A film forming apparatus 50 shown in FIG. 8 includes a first film forming container 51A and a second film forming container 51B. The film forming containers are connected to each other through a gate valve 57. Also, pipes 52 for introducing an adhesion promoter vapor and a water vapor obtained in the above embodiments are formed in a bottom surface of the first film forming container 51A, and pipes 53 for introducing a material monomer are formed in a bottom surface of the second film forming container 51B. Also, exhaust pipes 55A and 55B connected to an exhaust system (not shown) are respectively formed in the right sides of the film forming containers.

In the first film forming container 51A, a plurality of substrates S are held by a substrate supporting container, such as a boat (not shown), to be spaced apart from one another.

Also, the holding container 12 or the like as shown in FIGS. 1 and 5, or a portion surrounded by a dashed line as shown in FIG. 6 is connected to the pipes 52 so as to introduce vaporized adhesion promoter aqueous solution or the like into the first film forming container 51A. Even in this case, since the substrates S are disposed in the first film forming container 51A, the heater for heating and dehydrating in each of the apparatuses for treating a surfaces 10, 20, and 30 shown in FIGS. 1, 5, and 6 is formed in the first film forming container 51A, not in each of the processing containers 11, 21, and 31.

Also, a material monomer is supposed to be introduced into the second film forming container 51B from the pipes 53.

That is, the film forming apparatus 50 of the present embodiment is configured so that a pre-processing is performed on the substrates S by using the water-containing adhesion promoter vapor (water vapor and adhesion promoter vapor) in the first film forming container 51A, and that a film forming process is performed by introducing the material monomer in the second film forming container 51B.

In the film forming apparatus 50 shown in FIG. 8, like the apparatuses for treating a surfaces 10, 20, and 30 described with reference to FIGS. 1, 5, and 6, after an adhesion promoter vapor and a water vapor are first produced in the holding container 12 or the like or the first holding chamber 36 or the like, the adhesion promoter vapor and the water vapor are introduced into the first film forming container 51A through the pipes 52, to cause the hydrolysis reaction and the heating and dehydrating reaction (on surfaces of the substrates S) in the first film forming container 51A (pre-processing). Also, a remaining part of the adhesion promoter vapor or the like is exhausted to the outside from the first film forming container 51A through the exhaust pipe 55A.

Next, after the substrates S (the substrate supporting container) are moved into the second film forming container 51B, the substrates S are held at a predetermined temperature, a material monomer is introduced into the second film forming container 51B from the pipes 53 to cause a thermal polymerization reaction, and thus a polymer organic film is formed on the surfaces of the substrates S. Since the adhesion promoter is interposed between the substrate S and the polymer organic film due to the pre-processing, an adhesive force between the substrates S and the polymer organic film is improved.

Also, the gate valve 57 formed between the first film forming container 51A and the second film forming container 51B is in a closed state during the pre-processing and the film forming process, so that atmospheres in the containers do not interfere with each other. Also, a remaining part of the material monomer not contributing to the thermal polymerization reaction is exhausted to the outside from the second film forming container 51B through the exhaust pipe 55B.

While the present invention has been particularly shown and described with reference to the above specific embodiments, it will be understood by those skilled in the art that various changes in form and details may be made therein without departing from the spirit and scope of the invention as defined by the appended claims.

1. An apparatus for treating a surface of a substrate, the apparatus comprising:
a holding container which holds an aqueous solution containing an adhesion promoter in an amount of 20 vol. % or more;
a heater for vaporizing which produces a water-containing adhesion promoter vapor by heating and vaporizing the aqueous solution in the holding container to a temperature of 80° to 100° C.;
a heater for heating and dehydrating which causes a heating and dehydrating reaction after the water-containing adhesion promoter vapor is adhered to and condensed on the surface of the substrate, so as to chemically couple the adhesion promoter to the surface of the substrate; and
a processing container which holds the adhesion promoter vapor by receiving at least the holding container.

2. An apparatus for treating a surface of a substrate, the apparatus comprising:
a first holding container which holds an undiluted solution of an adhesion promoter;
a second holding container which holds water;
a first heater for vaporizing which produces an adhesion promoter vapor by heating and vaporizing the undiluted solution of the adhesion promoter in the first holding container;
a second heater for vaporizing which produces a water vapor by heating and vaporizing the water in the second holding container;
a heater for heating and dehydrating which chemically couples the adhesion promoter to the surface of the substrate after the water vapor and the adhesion promoter vapor, in which the ratio of the adhesion promoter is greater than a predetermined mixture ratio, is adhered to the surface of the substrate and hydrolyzed; and
a processing container which is connected to at least the first holding container and the second holding container to hold the adhesion promoter vapor and the water vapor.

3. The apparatus of claim 1, wherein the heater for heating and dehydrating heats the surface of the substrate to a temperature of 100° C. or more.

4. The apparatus of claim 1, wherein the adhesion promoter is a silane coupling agent.

5. An apparatus for forming an organic film, the apparatus comprising the apparatus of claim 1.

6. A method of treating a surface of a substrate, the method comprising:
holding in a holding container an aqueous solution which contains an adhesion promoter in an amount of 20 vol. % or more;
heating and vaporizing the aqueous solution to a temperature of 80 to 100° C. by using a heater for vaporizing to produce a water-containing adhesion promoter vapor, and holding the water-containing adhesion promoter vapor in a processing container; and
causing a heating and dehydrating reaction by using a heater for heating and dehydrating after the water-containing adhesion promoter vapor is adhered to and condensed on the surface of the substrate, so as to dehydrate and condense the adhesion promoter on the surface of the substrate.

7. A method of treating a surface of a substrate, the method comprising:
holding an undiluted solution of an adhesion promoter in a first holding container;
holding water in a second holding container;
heating and vaporizing the undiluted solution of the adhesion promoter in the first holding container by using a first heater for vaporizing to produce an adhesion promoter vapor, and holding the adhesion promoter vapor in a processing container;
heating and vaporizing the water in the second holding container by using a second heater for vaporizing to produce a water vapor, and holding the water vapor in the processing container; and
after the water vapor and the adhesion promoter vapor, in which the ratio of the adhesion promoter is greater than a predetermined mixture ratio, is adhered to the surface of the substrate and hydrolyzed, dehydrating and condensing the adhesion promoter by using a heater for heating and dehydrating so as to chemically couple the adhesion promoter to the surface of the substrate.

8. The method of claim 6, wherein the surface of the substrate is heated to a temperature of 100° C. or more by using the heater for heating and dehydrating.

9. The method of claim 6, wherein the adhesion promoter is a silane coupling agent.

10. A method of forming an organic film, the method comprising the method of claim 6.

11. The apparatus of claim 2, wherein the heater for heating and dehydrating heats the surface of the substrate to a temperature of 100° C. or more.

12. The apparatus of claim 2, wherein the adhesion promoter is a silane coupling agent.

13. An apparatus for forming an organic film, the apparatus comprising the apparatus of claim 2.

14. The method of claim 7, wherein the surface of the substrate is heated to a temperature of 100° C. or more by using the heater for heating and dehydrating.

15. The method of claim 7, wherein the adhesion promoter is a silane coupling agent.

16. A method of forming an organic film, the method comprising the method of claim 7.
